(19) United States
(12) Patent Application Publication
(10) Pub. No.: US 2017/0353856 A1
(43) Pub. Date: Dec. 7, 2017

(54) MOBILE COMMUNICATION SYSTEM AND METHOD

(71) Applicant: NEC CORPORATION, Tokyo (JP)

(72) Inventors: Xiaowei ZHANG, Tokyo (JP); Anand Raghawa PRASAD, Tokyo (JP)

(73) Assignee: NEC CORPORATION, Tokyo (JP)

(21) Appl. No.: 15/538,484

(22) PCT Filed: Dec. 21, 2015
(86) PCT No.: PCT/JP2015/006342

§ 371 Date: Jun. 21, 2017

(30) Foreign Application Priority Data
Dec. 22, 2014 (JP) 2014-259141

(51) Int. Cl. H04W 12/06; H04W 12/04; H04W 88/08; H04W 88/02

(52) U.S. Cl. CPC H04W 12/06; H04W 12/04; H04W 88/08; H04W 88/02

(57) ABSTRACT

There is provided a new message flow for improving security without backhaul connection to an EPC. In this message flow, an NeNB (20) updates PS UE list when an authorized PS UE (10) joins or leaves an Isolated E-UTRAN. Further, The NeNB (20) performs UE authentication based on pre-configured credentials. Further, the NeNB (20) can retrieve information necessary for the UE authentication from another NeNB to which the UE (10) previously attached. The NeNB (20) establish secure connection with the UE (10) based on pre-configured IOPS group key.

### TECHNICAL FIELD

The present invention relates to a mobile communication system and a mobile communication method, and particularly to a security without backhaul connection.

### BACKGROUND ART

In the current architecture, as disclosed in e.g., NPLs 1 and 2, an Isolated E-UTRAN (Evolved Universal Terrestrial Radio Access Network) contains one or more (N)eNBs ((Nomadic) Evolved Node Bs), with none or limited backhaul connection to EPC (Evolved Packet Core). The (N)eNB are connected with each other to form the Isolated E-UTRAN.

User data communication is routed locally, through one eNB in Isolated E-UTRAN. A UE (User Equipment) may be informed of other UE served by the eNB. UE mobility to another eNB with limited backhaul may happen. A PS (Public Safety) enabled UE (hereinafter, sometimes referred to as “PS UE”) can join/leave the Isolated E-UTRAN area.

### CITATION LIST

### Non Patent Literature

[NPL 1]: 3GPP TS 22.346, “Isolated Evolved Universal Terrestrial Radio Access Network (E-UTRAN) operation for public safety; Stage 1 (Release 13)”, V13.0.0, 2014-09

[NPL 2]: 3GPP TR 22.897, “Study on Isolated Evolved Universal Terrestrial Radio Access Network (E-UTRAN) Operation for Public Safety (Release 13)”, V13.0.0, 2014-06

### SUMMARY OF INVENTION

### Technical Problem

However, the inventors of this application have found that in the case where the Isolated E-UTRAN is operated with no backhaul to EPC, for example, the following threats (a) to (f) may be possible:

(a) Un-authenticated UE joins Isolated E-UTRAN;

(b) Un-authorized UE uses the usage of Isolated E-UTRAN, and communicates with other UEs in the same area;

(c) Overload, DoS (Denial of Service) attack to eNB;

(d) Eavesdropping, MitM (Man in the Middle) attack to the communication between UE and (N)eNB;

(e) Session hijack; and

(f) UE being stolen.

Since there is no backhaul connection, the current security mechanism does not apply.

Accordingly, an exemplary object of the present invention is to provide a solution for improving security without backhaul connection.

### Solution to Problem

In order to achieve the above-mentioned object, exemplary aspects of the present invention provide more details on a mobile communication system and a mobile communication method for UE authentication and authorization when a UE joins and leaves an isolated E-UTRAN with no backhaul connection. Instead of an MME (Mobility Management Entity), an eNB may be capable of authenticating and authorizing UEs. An (N)eNB may manage the list of authorized PS UE locally.

### Advantageous Effects of Invention

According to the present invention, it is possible to provide a solution for improving security without backhaul connection, thereby solving at least one of the above-mentioned threats, for example.

### BRIEF DESCRIPTION OF DRAWINGS

FIG. 1 is a block diagram showing a configuration example of a mobile communication system according to an exemplary embodiment of the present invention.

FIG. 2 is a sequence diagram showing a first operation example in the mobile communication system according to the exemplary embodiment.

FIG. 3 is a sequence diagram showing a second operation example in the mobile communication system according to the exemplary embodiment.

FIG. 4 is a sequence diagram showing a third operation example in the mobile communication system according to the exemplary embodiment.

### DESCRIPTION OF EMBODIMENTS

Hereinafter, an exemplary embodiment of a mobile communication system and a mobile communication method according to the present invention will be described with reference to the accompanying drawings.

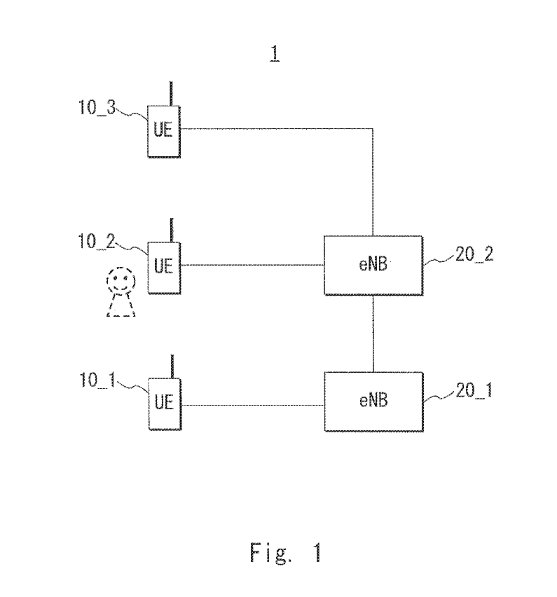

As shown in FIG. 1, a mobile communication system according to this exemplary embodiment deals with the case of operating with no backhaul to an EPC (not shown). This mobile communication system includes one or more UEs 10_1 to 10_3 (hereinafter, sometimes collectively denoted by the symbol 10), and one or more eNBs 20_1 and 20_2 (hereinafter, sometimes collectively denoted by the symbol 20). Note that although three UEs and two eNBs are shown in FIG. 1, the mobile communication system may be provided with UEs less or more than three, and eNBs less or more than two. In such cases, the following explanation can also be similarly applied.

The eNBs 20_1 and 20_2 are connected with each other to form an Isolated E-UTRAN 1. Each of the eNBs 20_1 and 20_2 can serve as an NeNB for at least one of the UEs 10_1 to 10_3, and thus locally route user data communication between the UEs 10_1 to 10_3.

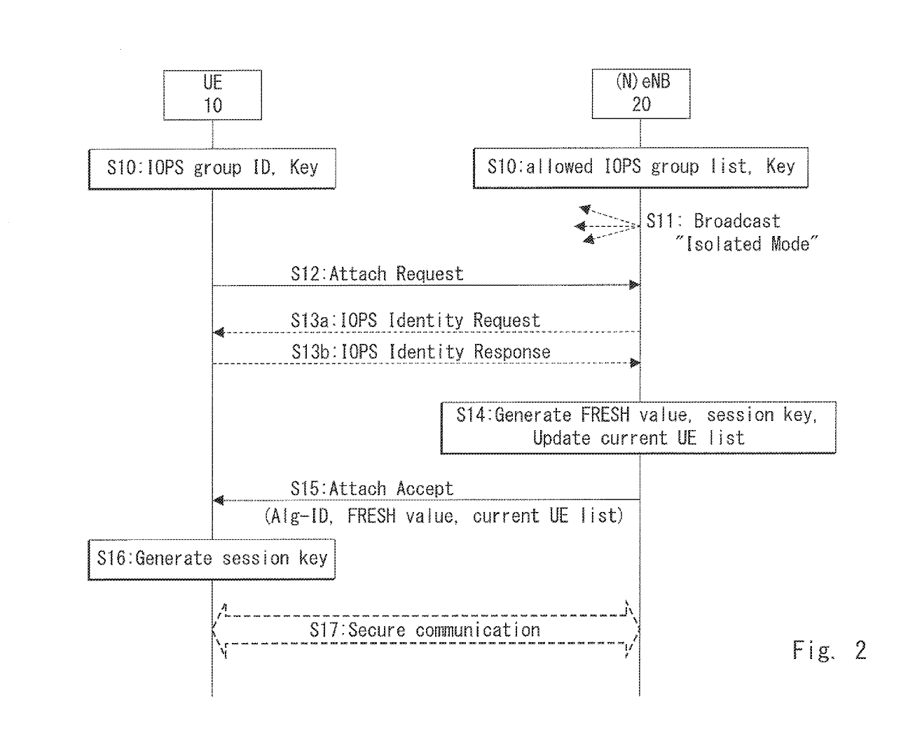

Next, there will be described operation examples of this exemplary embodiment with reference to FIGS. 2 to 4.

### 1. Preparation

The (N)eNB 20 and the UE 10 need necessary information for UE authentication, which can be obtained in one of the following ways.

1) The NeNB 20 can have pre-configuration or receive necessary information (from e.g., an MME), when the NeNB 20 was connected to the EPC. The UE 10 can also be pre-configured as with the NeNB 20.

2) The NeNB 20 requests UE security context from the previous eNB to which the UE 10 attached, if the eNB is in the neighborhood of the NeNB 20 and can be connected to the NeNB 20.

3) Anyone can come to join, with a key which can be verified. This shared key needs to be provided to both the UE 10 and the (N)eNB 20.

### 2. PS UE Joins the Isolated E-UTRAN

When the UE 10 joins the Isolated E-UTRAN 1, the (N)eNB 20 first verifies whether the UE 10 is a public safety enabled UE, and rejects the joining request if the UE 10 is not public safety enabled. The (N)eNB 20 initiates authentication procedure only when the requesting UE 10 is public safety enabled UE. If the UE 10 is authenticated, the (N)eNB 20 will setup secure connection with the UE 10, as in AS (Access Stratum) security setup procedure.

### 2.1. PS UE First Time Joins the Isolated E-UTRAN

It is assumed that the UE 10 and the NeNB 20 are pre-configured with IOPS (Isolated E-UTRAN Operations for Public Safety) group ID (identifier) and the associated group key. The NeNB 20 also stores a list of allowed IOPS group.

Specifically, at step S10 shown in FIG. 2, the public safety enabled UE 10 is pre-configured with credential for authentication to Isolated E-UTRAN 1. The (N)eNB 20 stores a list of allowed IOPS group of UEs that can access the Isolated E-UTRAN 1 to which this (N)eNB 20 belongs. Both the UE 10 and the (N)eNB 20 store IOPS group keys associated with group ID for this Isolated E-UTRAN 1.

At step S11, the NeNB 20 broadcasts its status of “Isolated Mode” with NeNB ID. The NeNB 20 can broadcast with signature that can be verified by the UE 10. The broadcast is an option.

At step S12, the UE 10 sends an Attach Request message to the (N)eNB 20.

If the UE 10 does not receive a broadcast of “Isolated Mode”, the UE 10 sends 1) Attach Request including IMSI (International Mobile Subscriber Identity) without protection, or 2) Attach Request including GUTI (Globally Unique Temporary Identity) with NAS (Non-Access Stratum) protection. After that, the following steps S13a and S13b will be carried.

If the UE 10 receives a broadcast of “Isolated Mode”, the UE 10 sends out an Attach Request message with its IOPS ID and group ID. This message is protected with IOPS group key.

At step S13a, since the (N)eNB 20 cannot read NAS message, the (N)eNB 20 requests for IOPS identity by sending an IOPS Identity Request message to the UE 10. At step S13b, the UE 10 sends the IOPS group ID in an IOPS Identity Response message. This message is protected with IOPS group key.

At step S14, the (N)eNB 20 verifies whether the UE 10 is public safety enabled UE and allowed to access for IOPS service. The verification is done by: 1) check IOPS group ID against the allowed UE list, 2) integrity verification of the message by using IOPS group key.

If the verification is successful, the (N)eNB 20 generates a fresh value, a session key from the fresh value and the IOPS group key, and update the current UE list.

At step S15, the (N)eNB 20 sends an Attach Accept message with algorithm ID (alg-ID) and the fresh value for session key derivation, and the current UE list to the UE 10. The Attach Accept message is integrity protected with the session key.

At step S16, the UE 10 generates the session key using the received alg-ID and fresh value. The UE 10 thus can verify the message integrity and NeNB authenticity.

At step S17, the UE 10 and the (N)eNB 20 starts secure communication.

### 2.2. PS UE Had Joined the Isolated E-UTRAN Previously

It is assumed that the UE 10 had attached to a certain (N)eNB before. The previous NeNB ID or a token allocated by that (N)eNB can be inserted to an Attach Request message to the New (N)eNB.

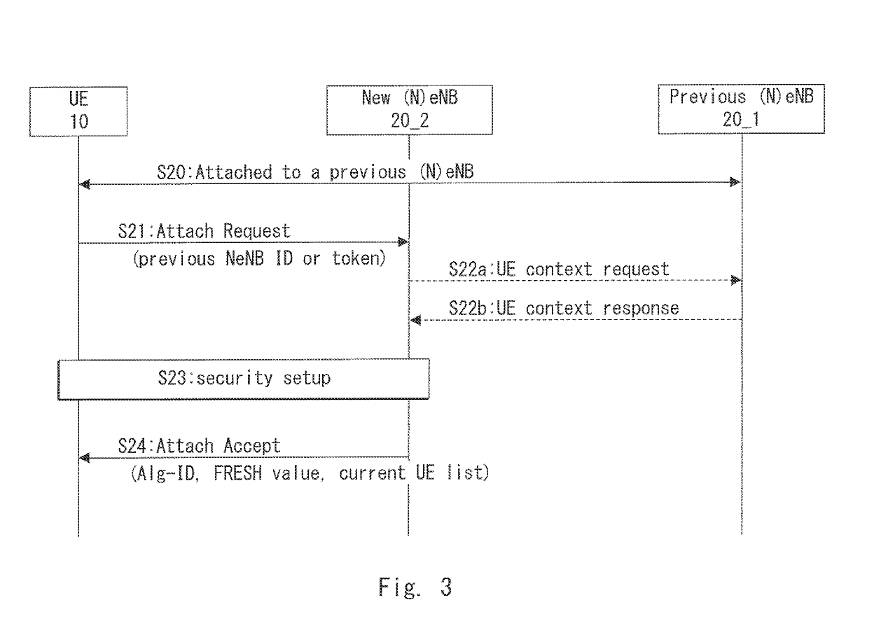

Specifically, at step S20 shown in FIG. 3, the UE 10 attached to a previous (N)eNB 20_1.

At step S21, the UE 10 sends an Attach Request message to the New NeNB 20_2. The UE 10 can insert, to this message, the previous NeNB ID or a token allocated by the Previous NeNB 20_1.

At step S22a, if the new (N)eNB 20_2 does not have sufficient UE information, the (N)eNB 20_2 contacts the (N)eNB 20_1 to which the UE 10 had attached before, by sending a UE Context Request message to the (N)eNB 20_1, and, at step S22b, retrieves necessary UE information in a UE Context Response message received from the (N)eNB 20_1, if the Previous (N)eNB 20_1 is at neighborhood.

If the a token is inserted in the Attach Request message, the New (N)eNB 20_2 can verify the token to authenticate the UE 10.

At step S23, the UE 10 and the New NeNB 20_2 establish security.

At step S24, the New NeNB 20_2 sends, to the UE 10, an Attach Accept message with alg-ID, fresh value and current UE list.

### 3. PS UE Leaves the Isolated E-UTRAN

If the UE 10 has left the Isolated E-UTRAN 1, the (N)eNB 20 updates the PS UE list, and will use this updated list as the latest list and perform the subsequent UE authorization according to the latest list.

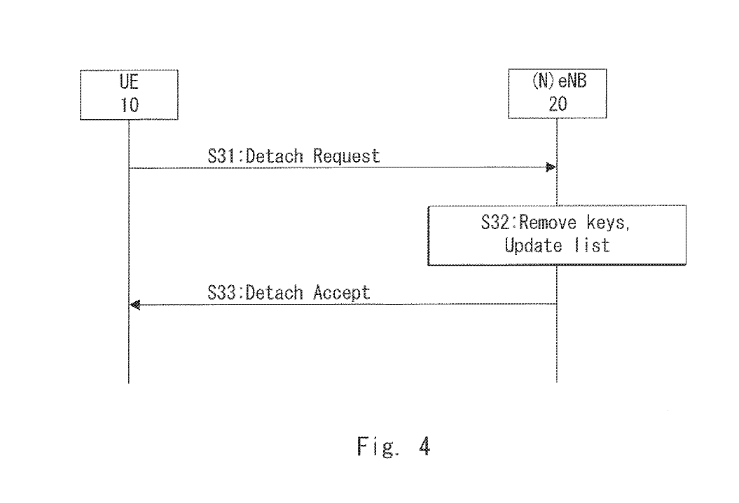

Specifically, at step S31 shown in FIG. 4, the UE 10 sends a Detach Request message to the (N)eNB 20.

At step S32, the (N)eNB 20 removes the above-mentioned keys, and updates the PS UE list.

At step S33, the (N)eNB 20 sends a Detach Accept message to the UE 10.

Note that the present invention is not limited to the above-mentioned exemplary embodiment, and it is obvious that various modifications can be made by those of ordinary skill in the art based on the recitation of the claims.

The whole or part of the exemplary embodiment disclosed above can be described as, but not limited to, the following supplementary notes.

### Supplementary Note 1

Message flow itself is novel.

### Supplementary Note 2

(N)eNB updates the PS UE list when an authorized PS UE joins or leaves the Isolated E-UTRAN.

### Supplementary Note 3

(N)eNB performs UE authentication based on pre-configured credentials.

### Supplementary Note 4

(N)eNB retrieves information from the (N)eNB that UE previously attached on.

### Supplementary Note 5

(N)eNB establish secure connection with UE based on pre-configured IOPS group key.

This application is based upon and claims the benefit of priority from Japanese patent application No. 2014-259141, filed on Dec. 22, 2014, the disclosure of which is incorporated herein in its entirety by reference.

### REFERENCE SIGNS LIST

1 Isolated E-UTRAN
10, 10_1-10_3 UE
20, 20_1, 20_2 (N)eNB

1-2. (canceled)

3. A user equipment connectable to a radio access network without backhaul connection, the user equipment comprising:
a memory configured to store a key for IOPS (Isolated E-UTRAN Operations for Public Safety) and an identity for IOPS,
wherein the user equipment is authenticated using credential containing the key for IOPS and the identity for IOPS.

4. The user equipment according to claim 3, wherein the user equipment accesses a service concerned with the IOPS.

5. A method of establishing IOPS (Isolated E-UTRAN Operations for Public Safety) for UE (user equipment) connectable to a radio access network without backhaul connection, the method comprising:
a step that the UE has a key for IOPS and an identity for IOPS; and
a step that the UE is authenticated using the key for IOPS and the identity for IOPS.

6. The method of establishing the IOPS according to claim 5, further comprising:
a step that the UE accesses a service concerned with the IOPS.
